(19) United States
(12) Patent Application Publication
(10) Pub. No.: US 2005/0008820 A1
(43) Pub. Date: Jan. 13, 2005

(54) Panel assembly and method for manufacturing the same

(76) Inventors: Heui Bom Lee, Ulsan-city (KR); Sang Myung Kim, Ulsan-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,653

(22) Filed: Dec. 31, 2003

(30) Foreign Application Priority Data
Jul. 10, 2003 (KR) 10-2003-0046907

(51) Int. Cl. B32B 3/04

(52) U.S. Cl. 428/124

(57) ABSTRACT

While manufacturing a panel assembly including inner and outer panels through a hemming process, part of the inner panel is compressed to the outer panel and an edge of the inner panel is hemmed with a flange portion of the outer panel such that a gap is formed therebetween.

### CROSS-REFERENCE TO RELATED APPLICATIONS

This application claims priority of Korean Application No. 10-2003-0046907, filed on Jul. 10, 2003, the disclosure of which is incorporated fully herein by reference.

### FIELD OF THE INVENTION

Generally, the present invention relates to a panel assembly for a vehicle. More particularly, the present invention relates to a panel assembly and a method for manufacturing the panel assembly.

### BACKGROUND OF THE INVENTION

Typically, the edges of the panel assembly are joined with a hemming process where two panels oppose each other, such as at a door, a hood, and a trunk lid of a vehicle. According to such a hemming process, a sharp edge of a constituent panel can be wrapped by a marginal portion of another panel, thereby creating an aesthetically pleasing and enhanced exterior shape of the panel assembly.

As shown in FIG. 1, a hemming process typically includes: \mathring{1} flanging an edge of an outer panel; \mathring{2} applying a hemming sealer to an interior side of the flange of the outer panel; \mathring{3} positioning an inner panel on the outer panel such that an edge of the inner panel lies in the portion spread with the hemming sealer; and \mathring{4} engaging the inner and outer panels by hemming an edge of the inner panel with the flanged edge of the outer panel. The hemming sealer used in the hemming process is heated and solidified by heat treatment of the panel assembly during a painting process and accordingly the solidified hemming sealer firmly holds the inner and outer panels together.

Typically, before the hemming sealer is sufficiently solidified, however, the hemming sealer may fail to hold the two panels together against an external impact. Therefore, after the inner and outer panels are engaged by hemming, contacting points of the inner and outer panels are temporary welded \mathring{5}, and an outer surface of the outer panel is ground smooth \mathring{6}.

By the above hemming step, step \mathring{4}, an attempt is made to have the inner panel in close contact with the outer panel. In the temporary welding step, step \mathring{5}, the panel assembly is spot welded at several welding points, as shown of FIG. 2. That is, by temporarily welding a conjoining portion 11 of the inner and outer panels can be tightly held together until the hemming sealer 21 is solidified by heat treatment of the painting process.

However, a drawback of this typical system is that a gap, usually of a non-uniform clearance, results between the inner and outer panels. Such a gap is almost inevitable, firstly because the hemming does not sufficiently ensure that the edges of the two panels are in perfect contact such that no gap is generated. In addition, the hemming sealer is applied in a limited amount such that it does not overflow from the conjoining portion. This implies that regions spread or not spread with the hemming sealer coexist between the marginal surfaces of the inner and outer panels.

Such a gap may produce a substantial amount of negative effects to durability of the panel assembly. That is, so-called white sealer, used as an anticorrosive for preventing corrosion of metallic panels, can not be sufficiently inserted into the narrow gap between the inner and outer panels.

The information disclosed in this Background of the Invention section is only for enhancement of understanding of the background of the invention and should not be taken as an acknowledgement or any form of suggestion that this information forms the prior art that is already known to a person skilled in the art in this country.

### SUMMARY OF THE INVENTION

The present invention provides a panel assembly and a method for manufacturing the same having enhanced anticorrosion characteristics.

An exemplary method for manufacturing a panel assembly having inner and outer panels according to an embodiment of the present invention includes forming a flange portion at an edge of the outer panel, applying a hemming sealer to an interior portion of the flange portion of the outer panel, positioning the inner panel at the flange portion of the outer portion that is applied with the hemming sealer, compressing the inner panel to the outer panel, and hemming an edge of the inner panel with the flange portion of the outer panel such that a gap of a predetermined clearance larger than zero (0) is formed between the inner panel and the edge of the outer panel.

In a further embodiment, the gap extends along the entire edge of the outer panel having the flange portion. It is preferable that the predetermined clearance lies in a range of about 0.4-0.6 mm.

In another further embodiment, the hemming sealer includes a plurality of beads that interconnect the inner and outer panels when the inner panel is compressed to the outer panel.

In yet another further embodiment, forming, in the gap, at least one layer of a phosphate layer and an electrodeposition layer is further included.

A panel assembly according to an embodiment of the present invention includes an inner panel, at least part of which is attached to an inner surface of an outer panel, wherein an edge of the outer panel is bent to a side of the inner panel opposite to the at least part of the inner panel. Furthermore, a gap of a predetermined clearance, larger than zero (0), is formed between the inner panel and the edge of the outer panel.

In a further embodiment, the gap extends along the entire edge of the outer panel bent to the inner panel. It is preferable that the predetermined clearance lies in a range of between about 0.4-0.6 mm.

In another further embodiment, the at least part of the inner panel is compressed to the outer panel interposing a hemming sealer. The hemming sealer including a plurality of beads that interconnect the inner and outer panels when the inner panel is compressed to the outer panel.

In yet another further embodiment, at least one layer of a phosphate layer and an electrodeposition layer is formed in the gap.

### BRIEF DESCRIPTION OF THE DRAWINGS

The accompanying drawings, which are incorporated in and constitute a part of the specification, illustrate an embodiment of the invention and read together with the following description serve to explain the principles of the invention:

FIG. 1 illustrates a process for manufacturing a panel assembly by a hemming process according to the prior art;

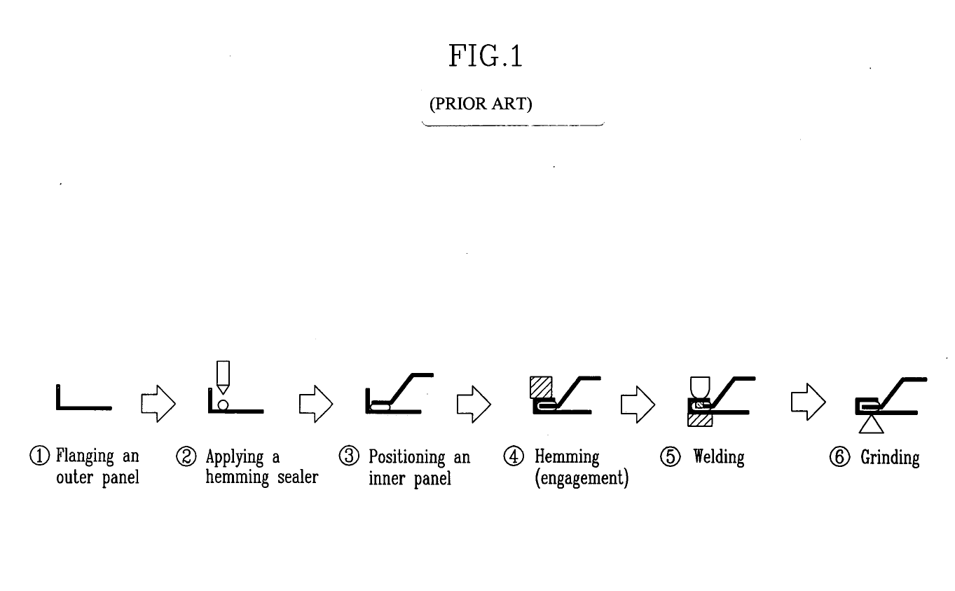

FIG. 2 illustrates temporary welding of a panel assembly during a hemming process according to the prior art;

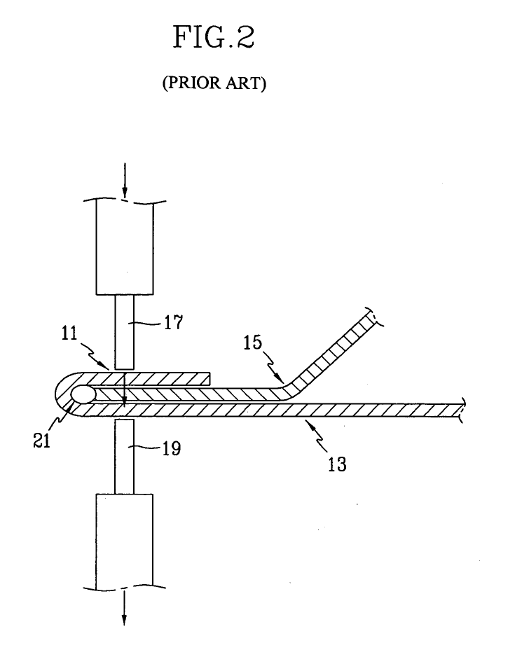

FIG. 3 is a flowchart showing a method for manufacturing a panel assembly according to an embodiment of the present invention; and

FIG. 4 is a sectional view of a panel assembly according to an embodiment of the present invention.

### DETAILED DESCRIPTION OF A PREFERRED EMBODIMENT

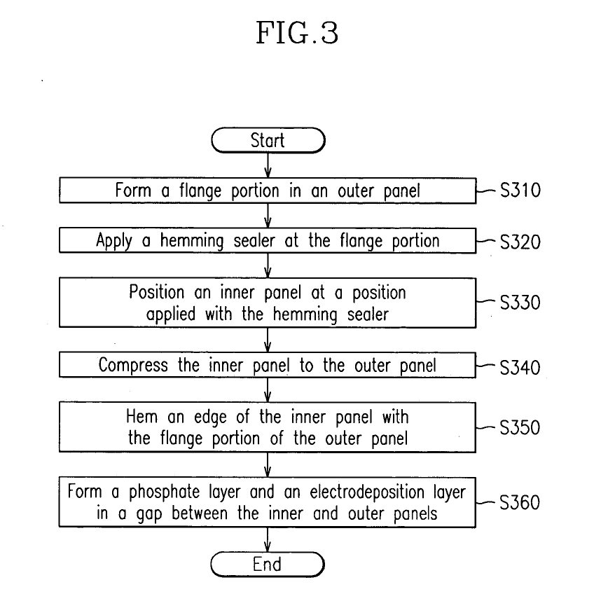

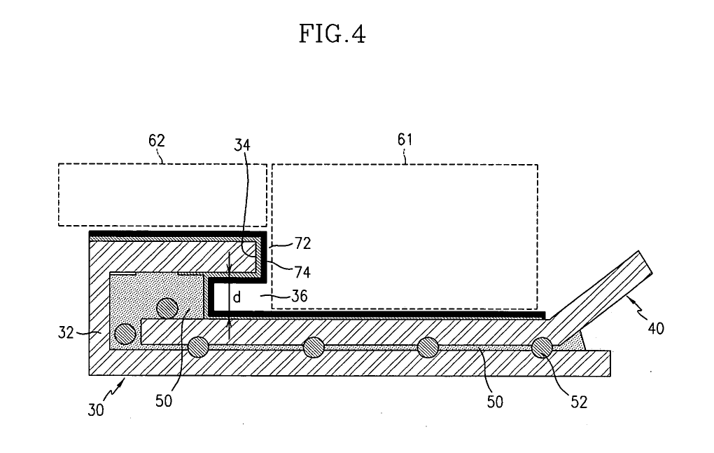

FIG. 3 shows a flowchart of a method for manufacturing a panel assembly and FIG. 4 is a sectional view of a panel assembly according to an embodiment of the present invention. As shown in FIG. 4, the panel assembly includes an outer panel 30 and an inner panel 40. Accordingly, the outer panel 30 and the inner panel 40 are preferably realized as metallic plates. However, the scope of the present invention should not be understood as being limited thereto.

As shown in FIG. 3, a flange portion 32 is formed by flanging an edge 34 of the outer panel 30 at step S310. At step S320, a hemming sealer 50 is spread in an interior side of the flange portion 32 of the outer panel 30 flanged at the step S310. Subsequently, the inner panel 40 is positioned to the interior side of the flange portion 32, at step S330. More particularly, the inner panel 40 is positioned at a portion that is applied with the hemming sealer 50. At step S340, the inner panel 40 is compressed to the outer panel 30 with a first punch 61.

Additionally, an edge of the inner panel 40 is hemmed with the flange portion 32 of the outer panel 30, at step S350, such that a gap 36 of a predetermined clearance “d,” larger than zero (0), is formed between the inner panel 40 and the edge of the outer panel 30. The compression step S340 and the hemming step S350 may be simultaneously executed. The gap 36 extends along the entire edge 34 of the outer panel 30. The predetermined clearance “d” lies in a range of between about 0.4-0.6 mm, and for example, has a value of 0.5 mm.

The hemming sealer 50 includes a plurality of beads 52. The beads interconnect the inner and outer panels 40 and 30 when the inner panel 40 is compressed to the outer panel 30. Therefore, because of the beads 52, the inner and outer panels 40 and 30 are mechanically locked to each other. The rigidity of the beads 52 is greater than that of the inner and outer panels 40 and 30. FIG. 4 illustrates the beads 52 as spherical, but the exterior shape of the beads 52 should not be understood as being limited thereto.

When a basic structure of the panel assembly is formed as such, a phosphate layer 72 and an electrodeposition layer 74 are consecutively formed, at step S360, to cover any surfaces exposed in the interior and exterior of the gap 36, such that, corrosion of possibly exposed surfaces is prevented.

During the anticorrosion treatment, at step S360, the phosphate layer 72 and electrodeposition layer 74 can easily enter the gap 36 and cover the surfaces therein. This is because the gap 36 has a relatively substantial clearance. Therefore, the phosphate layer 72 and/or electrodeposition layer 74 prevent corrosion of the inner outer panels 40 and 30 in the gap 36.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A method for manufacturing a panel assembly having inner and outer panels, comprising:
forming a flange portion at an edge of an outer panel;
applying a hemming sealer to an interior portion of the flange portion of the outer panel;
positioning an inner panel at the flange portion of the outer panel that is applied with the hemming sealer;
compressing the inner panel to the outer panel; and
hemming an edge of the inner panel with the flange portion of the outer panel such that a gap of a predetermined clearance larger than zero (0) is formed between the inner panel and an edge of the outer panel.

2. The method of claim 1, wherein the gap extends along the entire edge of the outer panel having the flange portion.

3. The method of claim 2, wherein the predetermined clearance lies in a range of between about 0.4-0.6 mm.

4. The method of claim 1, wherein the hemming sealer comprises a plurality of beads that interconnect the inner and outer panels when the inner panel is compressed to the outer panel.

5. The method of claim 1, further comprising forming, in the gap, at least one layer of a phosphate layer and an electrodeposition layer.

6. A panel assembly comprising:
an outer panel; and
an inner panel at least part of which is attached to an inner surface of the outer panel,
wherein an edge of the outer panel is bent to a side of the inner panel opposite to the at least part of the inner panel, and
a gap of a predetermined clearance larger than zero (0) is formed between the inner panel and the edge of the outer panel.

7. The panel assembly of claim 6, wherein the gap extends along the entire edge of the outer panel bent to the inner panel.

8. The panel assembly of claim 7, wherein the predetermined clearance lies in a range of between about 0.4-0.6 mm.

9. The panel assembly of claim 6, wherein the at least part of the inner panel is compressed to the outer panel interposing a hemming sealer, the hemming sealer comprising a plurality of beads that interconnect the inner and outer panels when the inner panel is compressed to the outer panel.

10. The panel assembly of claim 6, wherein at least one layer of a phosphate layer and an electrodeposition layer is formed in the gap.
